(19) United States
(12) Patent Application Publication
(10) Pub. No.: US 2023/0415789 A1
(43) Pub. Date: Dec. 28, 2023

(54) AERIAL TRANSPORTATION INSTALLATION TERMINAL AND METHOD FOR PERFORMING MAINTENANCE OF A TERMINAL

(71) Applicant: POMA, Voreppe (FR)

(72) Inventors: Guillaume DARIER, Varces-Allières-et-Risset (FR); Rémi MANFREDI, Voreppe (FR)

(73) Assignee: POMA, Voreppe (FR)

(21) Appl. No.: 18/214,936

(22) Filed: Jun. 27, 2023

(30) Foreign Application Priority Data
Jun. 27, 2022 (FR) 2206398

(51) Int. Cl. B61B 1/00; B61B 12/02

(52) U.S. Cl. CPC B61B 1/00; B61B 12/024

(57) ABSTRACT

An aerial transportation installation is provided with a carrier vehicle and a terminal. The terminal comprises a moving device to move the carrier vehicle in the terminal. The moving device defines a running path of the carrier vehicle and moves the vehicle. A platform is arranged on one side of the running path. The platform allows movement alongside the moving device and enables an operation to be performed on the moving device. The terminal defines a running space for a grip of the carrier vehicle. The moving device is arranged between the platform and the running space. An additional platform is movable between first and second positions. In a first position, the additional platform does not form an obstacle to progression of the vehicle. The second position enables maintenance to be performed on the moving device.

### BACKGROUND OF THE INVENTION

The invention relates to a terminal of an aerial transportation installation and to a method for performing maintenance of an aerial transportation installation terminal.

### PRIOR ART

To move people or goods, it is known to use aerial transportation installations. These aerial transportation installations comprise one or more terminals as well as towers. A cable defines a running path for the carrier vehicles to run between the terminals. The cable is driven by means of a motor. One or more carrier vehicles are fixed to the cable and move along the running path.

Like any transportation installation, the aerial transportation installation is regularly subjected to maintenance operations which notably implies that the different components which form the terminal have to be accessible to one or more operators in order to analyse and if necessary repair the component parts forming the terminal.

For this purpose, it is conventional to form a terminal that is provided with an internal platform which runs alongside the carrier vehicle running path so as to be able to observe and if necessary perform action on the equipment that drives the cable and/or the carrier vehicles in the terminal. To ensure the safety of the maintenance personnel, the moving parts and in particular the drive wheels and sheaves which drive the cable and/or the vehicles are protected by a shrouding. The shrouding prevents the operator who is moving around on the platform from being caught up by a moving part.

The shrouding is fitted movable between a first position ensuring protection of the personnel and a second position that enables operations to be performed on the movable equipment and in particular on the drive wheels.

However, when the operator has to work on the drive wheels, it is observed that the configuration is not always very practical as the running platform is located at a certain distance from the drive wheels. In certain configurations, the drive wheels and platform may be separated by a girder supporting the rotation axes of the drive wheels. This has the result that during maintenance operations, the operators cannot always work under the most suitable conditions.

It is also important to limit the dimensions of the terminal of the aerial transportation system which tends to involve making a trade-off between the dimensions of the terminal and ease of access to the different components of the terminal.

### OBJECT OF THE INVENTION

One object of the invention consists in providing an aerial transportation installation terminal facilitating maintenance operations on the equipment responsible for moving the cable and/or the vehicles without increasing the dimensions of the terminal.

According to one feature of the invention, an aerial transportation installation terminal is proposed provided with at least one carrier vehicle, the terminal comprising:
a moving device configured to move the at least one carrier vehicle in the terminal, the moving device defining a running path of the at least one carrier vehicle in the terminal, the moving device comprising a plurality of moving parts that are able to move the at least one carrier vehicle in the terminal;
a platform located on a first side of the running path, the platform being configured to allow an operator to move alongside the moving device and to enable him/her to perform maintenance operations on the moving device;
at least one shrouding at least partially covering the moving device to separate the operator present on the platform and the moving device;
the terminal defining a running space designed to let a grip of the at least one carrier vehicle run, the grip fixing the at least one carrier vehicle to the cable, the moving device being arranged between the platform and the running space.

The terminal is remarkable in that it comprises an additional platform movable between a first position and a second position different from the first position;
wherein the first position is a position where the additional platform does not constitute an obstacle to the progression of the at least one carrier vehicle in the running path and wherein the second position is a position able to support the operator to enable him to perform an operation on the moving device;
and in that, in the second position, the additional platform is arranged on a second side of the running path facing the platform, the second side being opposite the first side with respect to the running path in a vertical observation.

In advantageous manner, in the first position, the additional platform is at least partially located on the first side with respect to the running path.

In a particular configuration, in the first position, the additional platform is mainly located on the first side with respect to the running path.

In an advantageous development, in the second position, the additional platform is located in the space designed to be occupied by the grip, the additional platform forming an obstacle to running of the at least one carrier vehicle in the terminal.

Preferentially, the terminal further comprises a roof panel. The roof panel defines a supplementary platform designed to support the operator, the supplementary platform being offset from the additional platform in a first direction perpendicular to the running path of said at least one carrier vehicle, the supplementary platform being arranged at a lower height than the height of the additional platform and being offset to locate the additional platform between the plurality of wheels and the supplementary platform so that the additional platform forms a work surface, the height of the supplementary platform being less than the height of the additional platform.

According to one embodiment, the moving device comprises at least one wheel configured to move the carrier vehicle in the terminal. The altitude of the additional platform is lower than the altitude of an axis of rotation of the at least one wheel.

In an advantageous development, the additional platform is formed by a first plate and a second plate, the second plate being mounted movable with respect to the first plate, the second plate being mounted movable between a protection position and a retracted position, wherein the protection position of the second plate extends upwards from the first plate and wherein in the retracted position the second plate is pressing against the first plate.

Preferentially, in the first position, the additional platform forms the shrouding.

In another advantageous development, the additional platform is mounted rotatable between the first position and the second position.

It is a further object of the invention to provide a method for performing maintenance that is easier to perform than in the prior art configurations.

This result tends to be achieved by means of a method for performing maintenance of an aerial transportation installation terminal comprising the following steps:
providing a terminal in accordance with any one of the foregoing configurations;
moving the additional platform from the first position to the second position, the second position supporting an operator performing maintenance on the moving device, the first position being a position where the additional platform is outside the running space of the carrier vehicles in the terminal.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a side view of a terminal with an additional platform in a first position;

FIG. 2 schematically illustrates a perspective view of the terminal with the additional platform in the first position;

FIG. 3 schematically illustrates a top view of the terminal with the additional platform in the first position;

FIG. 4 schematically illustrates a side view of the terminal with the additional platform in an intermediate position;

FIG. 5 schematically illustrates a perspective view of the terminal with the additional platform in the intermediate position;

FIG. 6 schematically illustrates a top view of the terminal with the additional platform in the intermediate position;

FIG. 7 schematically illustrates a side view of the terminal with the additional platform in a second position with a guard rail;

FIG. 8 schematically illustrates a perspective view of the terminal with the additional platform in the second position with a guard rail;

FIG. 9 schematically illustrates a top view of the terminal with the additional platform in the second position with a guard rail;

FIG. 10 schematically illustrates a side view of the terminal with the additional platform in the second position and forming a work surface;

FIG. 11 schematically illustrates a perspective view of the terminal with the additional platform in the second position and forming the work surface;

FIG. 12 schematically illustrates a top view of the terminal with the additional platform in the second position and forming the work surface.

### DESCRIPTION OF THE EMBODIMENTS

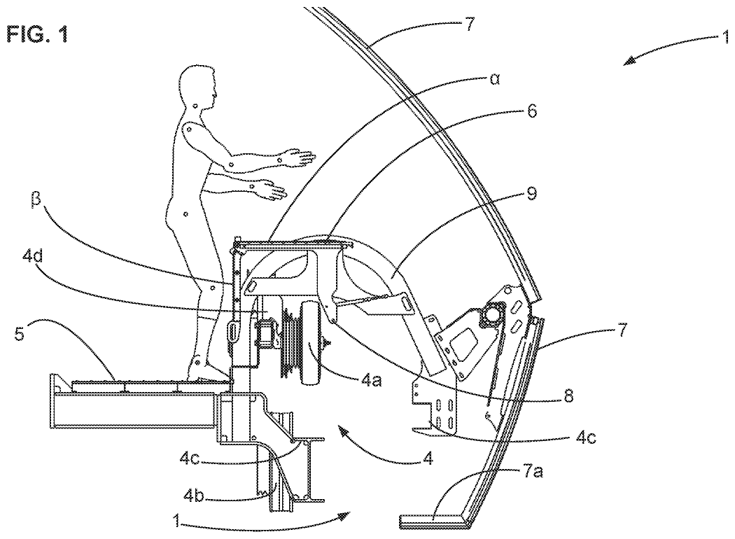

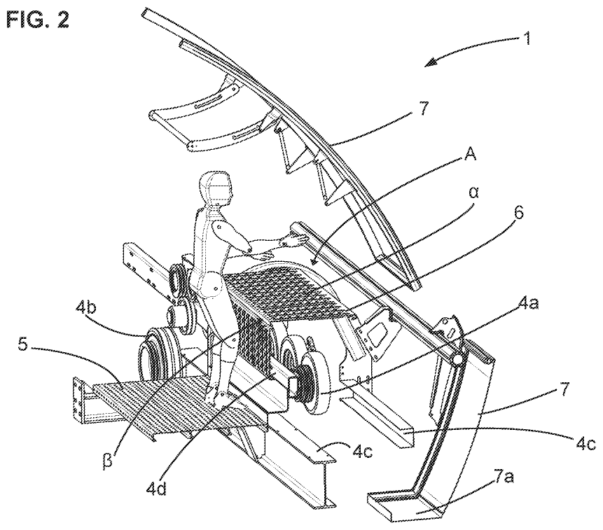

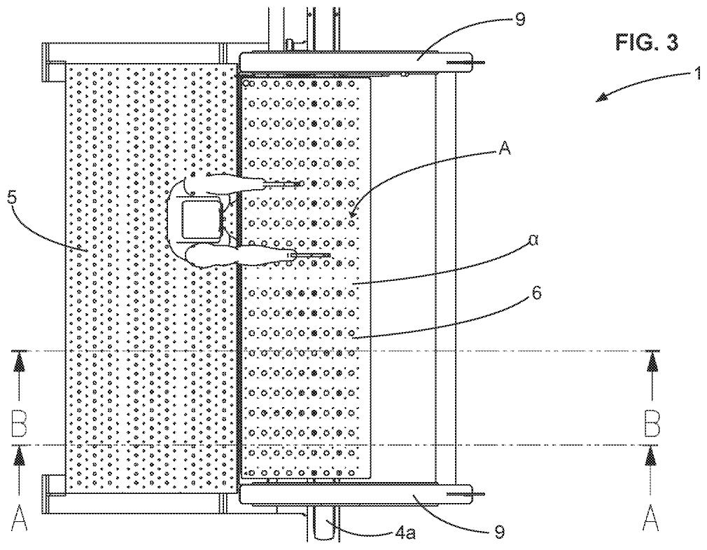

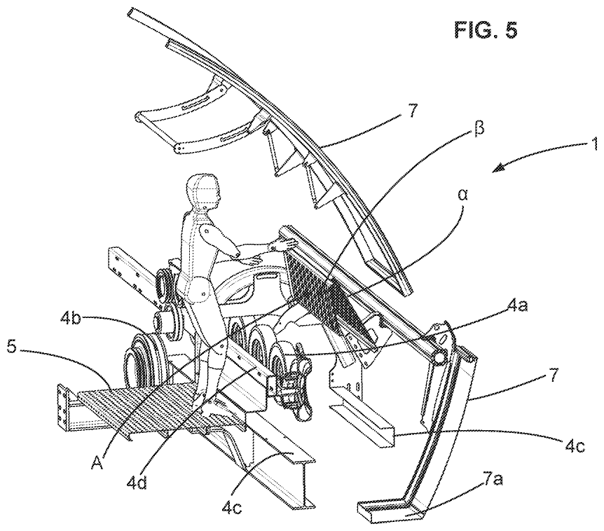

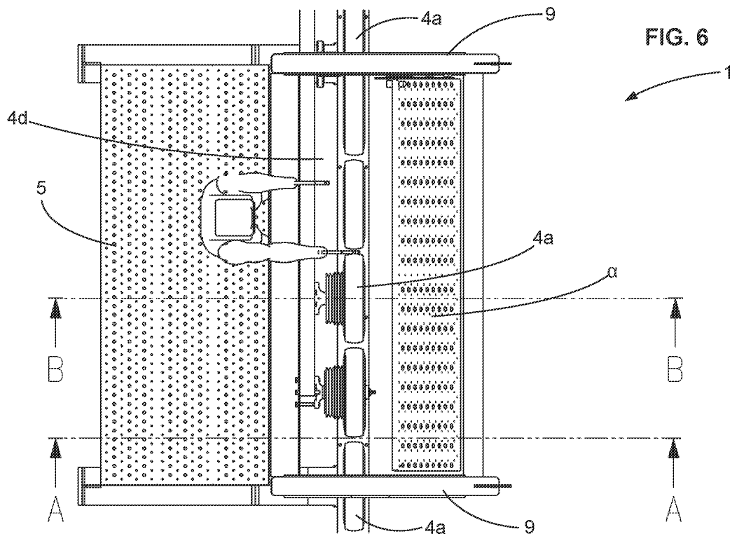

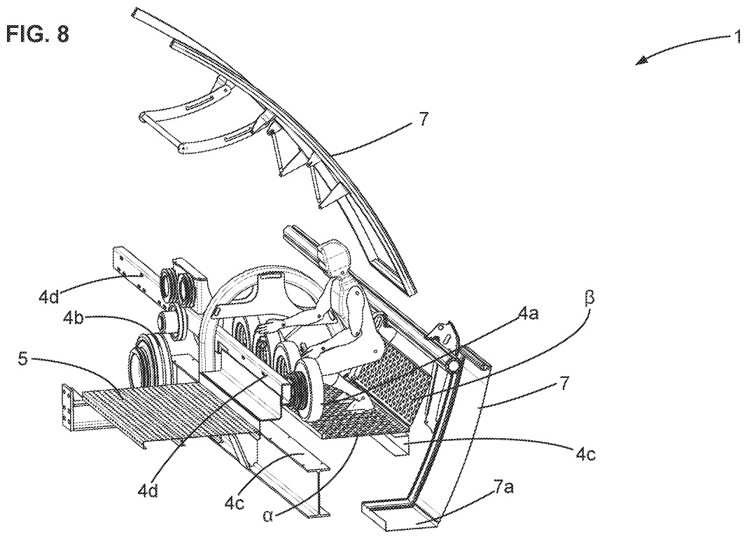

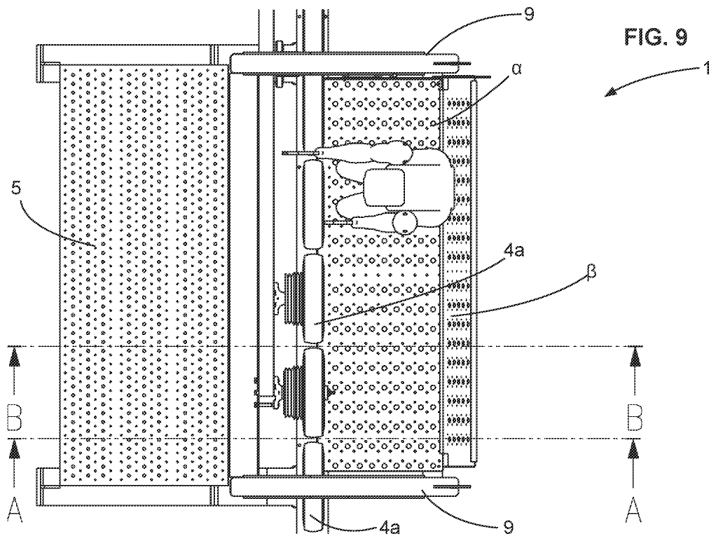

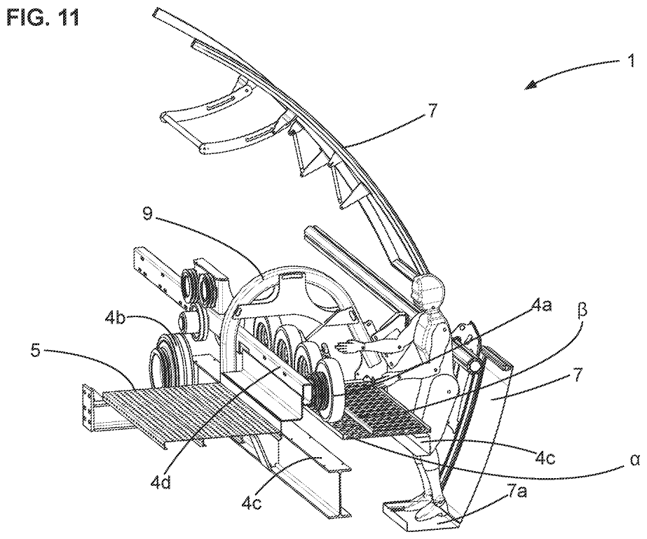

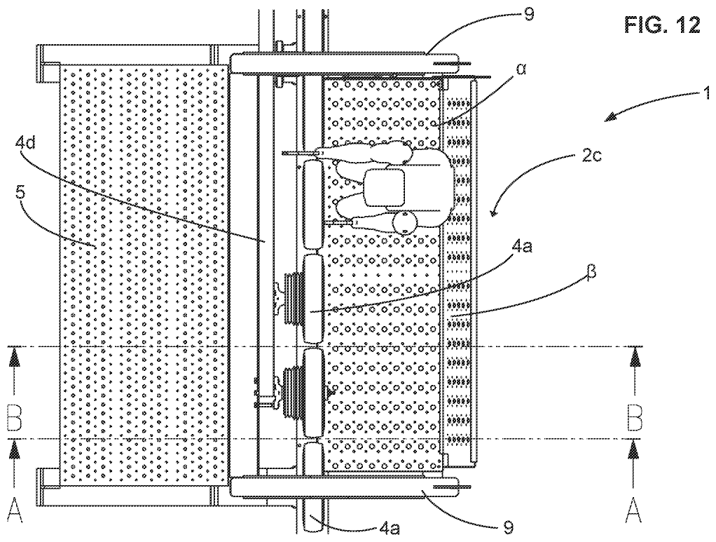

FIGS. 1 to 12 illustrate different views of a terminal 1 of an aerial transportation installation in different configurations. The aerial transportation installation comprises one or more terminals 1, for example two terminals possibly with intermediate stations. The aerial transportation installation has one or more carrier vehicles. The aerial transportation installation defines a running path for the carrier vehicle or vehicles. The running path is totally or partially defined by a cable 2 or by several cables 2. In preferential manner, when the aerial transportation installation has several terminals 1, cable or cables 2 join terminals 1 to one another.

The aerial transportation installation comprises a drive means of the cable that is configured to drive the cable 2. The cable drive means has for example at least one motor. The cable drive means can be located in terminal 1 or elsewhere.

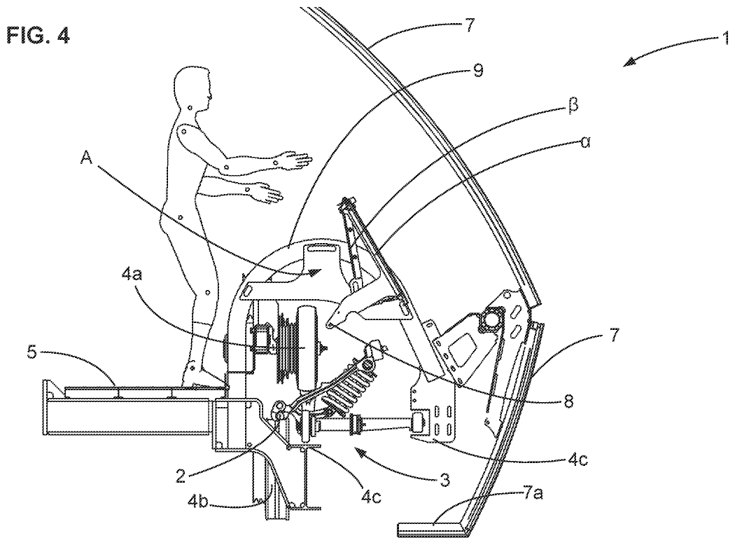

The carrier vehicle or vehicles are fixed to the cable 2 by a grip 3 or at least one grip 3. Depending on the configurations, the carrier vehicles are fixedly secured to the cable 2 or are fitted in detachable manner with respect to the cable 2. The grip 3 is adapted accordingly. FIG. 4 illustrates a configuration of a detachable grip 3 enabling the cable 2 and the vehicle to be uncoupled from one another.

The terminal 1 has a moving device 4, also called driving device, configured to enable movement of the at least one carrier vehicle in the terminal 1, for example movement of the carrier vehicle through the terminal 1. The moving device 4 partially defines the running path of the carrier vehicle and in particular in the running path in the terminal 1 and preferentially through the terminal 1.

In order to make it easier for an operator to move around in the terminal 1, the latter has a platform 5. The platform 5 defines a path enabling the operator to move between the different parts of the terminal 1. The platform 5 is located on a first side of the moving device 4. When the running path defines a “U” shape, the platform is preferentially located on the internal side of the running path, i.e. the inside of the “U”. The platform 5 is located facing the moving device 4, i.e. at the same altitude as the moving device 4 or substantially at the same altitude so that the operator can access the components of the moving device 4 in the standing or preferentially the kneeling position. The platform 5 is preferentially arranged to be farther from the components of the grip 3 of the vehicle than from the cable 2 so as to reduce the overall dimensions of the terminal 1.

The platform 5 is arranged at a height so as not to form an obstacle to satisfactory running of the carrier vehicles in the terminal 1. In general manner, the platform 5 does not constitute an obstacle for the components designed to move the cable 2 and also for the vehicle diversion components if applicable. The arrangement of the platform 5 and of the other components of the terminal is performed in astute manner so as to find the best trade-off between the dimensions of the terminal 1 and the ease of performing maintenance operations. In preferential manner, the platform 5 is located above the car or the seat when the aerial transportation installation is a gondola lift or a chair lift. The platform is arranged in such a way as to allow the transportation installation to operate.

In order to protect the operator during operation of the aerial transportation installation, the components constituting the moving device 4 are not easily accessible or are not able to be accessed by the operator moving on the platform 5. The same is advantageously the case for the cable 2 and/or the part of the carrier vehicle that is located in proximity to the platform, for example the grip 3.

FIG. 1 illustrates an embodiment in which the moving device 4 is rendered inaccessible from the platform 5 by means of a shrouding 6. The shrouding 6 partially covers the moving device 4 so that the at least one shrouding 6 is located between the operator situated on the platform 5 and the moving device 4. In the illustrated embodiment, the shrouding 6 is in the form of a protective corner preventing access to the components of the moving device 4 in a horizontal direction and in a vertical direction. Another form of shrouding 6 is possible.

In order to be able to perform maintenance operations, the at least one shrouding 6 presents a first position which is a protection position preventing access to all or part of the moving device 4 and a second position which is an intervention position allowing access. Depending on the configurations, the shrouding 6 or shroudings are fitted movable or deformable between the protection position and the intervention position.

Switching from the protection position to the intervention position can be achieved by deformation of the shrouding 6, by retraction of the shrouding 6, by movement of the shrouding 6, for example by rotation of the shrouding 6, and possibly by removal of the shrouding 6. In preferential manner, switching from the first position to the second position results in shutdown of the aerial transportation installation and/or is only possible when the installation is shut down. The shrouding 6 can be provided with a sensor that detects that the shrouding 6 is no longer in the first position and/or can be provided with a lock preventing the shrouding 6 from being moved from the first position when the installation is not shut down, i.e. is in operation.

In a particular embodiment illustrated in FIGS. 1 to 12, the moving device 4 is a moving device of an aerial transportation installation for carrier vehicles with the detachable grip 3. The moving device is then configured to move the cable 2 and the at least one carrier vehicle separately over a part of the running path. The moving device 4 has a plurality of moving parts, preferably rotatable parts that are designed to move the cable 2 and/or the carrier vehicles in the terminal 1. The rotatable parts are preferentially the wheels 4a and/or the sheaves 4b designed for movement of the cable 2 or of carrier vehicles. In one embodiment, one or more of the rotatable parts are mounted idle. In another embodiment, one or more of the rotatable parts are driven in rotation. It is also possible to have the sheaves 4b mounted idle or the wheels 4a that drive the carrier vehicles.

As illustrated in FIGS. 1 to 12, the terminal preferentially has a series of wheels 4a performing driving of the at least one carrier vehicle along the running path. The wheels 4a are arranged one after the other to define a part of the running path.

As illustrated in FIG. 4 and in the other figures, the terminal 1 has one or more sheaves 4b that support or press on the cable 2. The sheaves 4b participate in movement of the cable 2 inside the terminal 1.

The moving parts are fitted one after the other to define the running path. For example the moving parts are aligned one after the other to define a straight portion. In another embodiment, the moving parts are arranged one behind the other to define a curve or another shape.

To facilitate running of the at least one carrier vehicle in the terminal 1, it is advantageous to have one or more rails 4c, for example two rails 4c supporting the vehicle. In the terminal 1, the carrier vehicle runs on the at least one rail 4c that defines the running path for the carrier vehicle. Rails 4c support at least one pair of wheels of the carrier vehicle. Two facing rails 4c are separated by a space for the carrier vehicle arm to pass. It is advantageous for the wheels 4a to be mounted on a beam 4d.

The platform 5 is offset laterally with respect to the moving device 4 and is situated outside the space for passage of the carrier vehicles in the terminal 1. The offset arrangement of the platform 5 in the terminal 1 means that the moving device 4 is not easily accessible for the operator and that certain components of the moving device 4 become difficult to handle, in particular the wheels 4a. This results in, when performing a maintenance operation, the operator may find himself in an uncomfortable position. The space for passage of the carrier vehicles represents the minimum space occupied by the carrier vehicle running in the terminal 1 along the running path. The passage space corresponds substantially to the lateral dimension of the carrier vehicle and defines the volume in which a part cannot be installed as it will form an obstacle for passage of the carrier vehicle. At the altitude of the moving device 4, the passage space is mainly or exclusively defined by the grip 3 and the arm that supports the car or seat of the carrier vehicle.

To make the operator's job easier, it is advantageous to provide a terminal 1 that is equipped with an additional platform A. The additional platform A is movable between a first position and a second position different from the first position. The first position is a position where the additional platform does not form an obstacle to the progression of the at least one carrier vehicle in the running path. The second position of the additional platform A is a position that is able to support the operator to enable an operation to be performed on the moving device 4. In the second position, the additional platform A is arranged on a second side of the running path facing the platform 5, the second side being opposite the first side with respect to the running path in a vertical observation.

The additional platform A is a platform that is located on the other side of the moving device 4 to make maintenance operations easier to perform. The operator can go from the platform 5 to the additional platform A in complete safety, i.e. from the first side to the second side so as to be able to work more efficiently on the moving device 4 with another point of view. The platform 5 enables work to be performed from one side of the moving device 4 whereas the additional platform A enables work to be performed from the other side of the moving device 4. The additional platform A is preferentially made from metal.

What is meant by “the additional platform A is arranged on a second side of the running path” is that the additional platform A is mainly situated on the second side or even exclusively on the second side.

In preferential manner, in the first position, the additional platform A is arranged on the first side of the running path, i.e. mainly situated on the first side or even exclusively on the first side. By being situated on the first side, the additional platform A is more easily accessible to the operator and reduces the space occupation of the second side when the carrier vehicles are running. This can make it possible to have an outer wall of the terminal 1 that is closer to the running space of the carrier vehicles.

In the second position, the additional platform A is horizontal or substantially horizontal to make the operator's job safer. In preferential manner, the additional platform A has a surface that is larger than 1 m².

In a particular embodiment, in the second position, the additional platform A is arranged in the running space of carrier vehicles and it obstructs this running space. This arrangement makes operations on the moving device 4 easier to perform. In the second position, the additional platform A prevents the at least one carrier vehicle from running through the terminal 1. Advantageously, in the second position, the additional platform A occupies the space designed to be occupied by grip 3 of a carrier vehicle. In other words, if the carrier vehicle is running, the grip 3 will strike the additional platform A. In preferential manner, the terminal 1 has a sensor configured to detect the presence of the additional platform A in the second position and to prevent the aerial transportation installation from being started up when detection takes place.

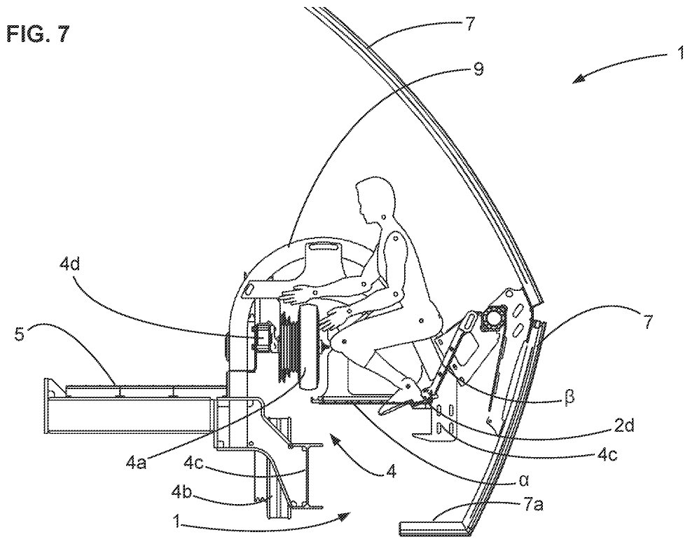

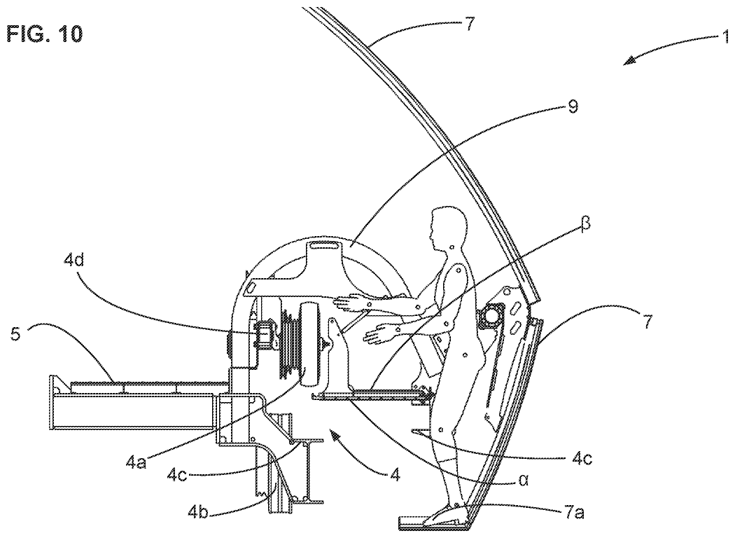

In an advantageous embodiment, when the moving device 4 is provided with the wheels 4a that move the carrier vehicle, it is advantageous for the additional platform A to be located at an altitude that is lower than the altitude of the axis of rotation of the wheel 4a facing it. In even more advantageous manner, the additional platform A is at an altitude that is lower than altitude of wheel 4a that is facing it. In preferential manner, the difference between the altitude of the platform 5 and the altitude of the lowest area of wheel 4a is less than 50 cm to make wheel 4a easier to dismantle. Such an embodiment is illustrated in FIGS. 7 and 10. By moving the additional platform A downwards, operator action is made easier. What is meant by “facing it” is wheel 4a that is facing the additional platform in a vertical plane passing through the axis of rotation of wheel 4a. In the second position, the additional platform can be at an altitude that is equal to or lower than the altitude of the platform 5 in the area perpendicularly facing the running path as illustrated in FIGS. 7 and 10. Preferentially, during movement between the first position and the second position, the additional platform never reaches the altitude of the car or seat.

In an advantageous embodiment illustrated in FIGS. 1 to 12, the terminal 1 also comprises a roof panel 7. The roof panel 7 forms a roof on the top of the terminal 1. The roof panel 7 defines a supplementary platform 7a designed to support the operator. Supplementary platform. 7a is offset from the additional platform A in the first direction perpendicular to the running direction of the at least one carrier vehicle. The supplementary platform 7a is located at a lower height than the height of the additional platform A and is offset to locate the additional platform A between the plurality of wheels and the supplementary platform 7a, in a vertical observation, so that the additional platform A forms a work surface.

The roof panel 7 is designed to form the roof of the terminal 1 to protect the components of the terminal 1 against bad weather, in particular rain and snow. The roof panel 7 forms a detachment that is sufficiently large and sufficiently resistant so as to define the supplementary platform 7a that is able to support the operator's weight. When the roof panel 7a is formed by a metal plate, it is possible to reinforce the supplementary platform 7a so that the plate supports the user's weight. The supplementary platform 7a is horizontal or substantially horizontal.

When the operator has climbed onto the supplementary platform 7a, the operator is separated from the moving device 4 by the additional platform A and the supplementary platform 7a is located at an altitude such that the additional platform A forms a work surface. The operator can then dismantle a component of the moving device 4 and place it on the additional platform to work on the component he/she has removed. The difference of altitude between the additional platform and the supplementary platform 7a is advantageously comprised between 0.75 and 1.5 m. It is advantageous to modify the roof panel 7 to be able to support the weight of the operator and to use the additional platform A as work surface. This enables an additional functionality be provided without increasing the overall dimensions of the terminal 1.

In a particular embodiment illustrated in FIGS. 1 to 12, the additional platform A is formed by a first plate α and a second plate β. The second plate β is fitted movable with respect to the first plate α, for example by means of a hinge. At least the first plate α is designed to support the operator. Preferentially, the second plate β is fitted movable between a protection position and a retracted position. In the protection position, the second plate β extends upwards from the first plate a. In the retracted position, the second plate β is pressing against the first plate α, against the top surface or against the bottom surface. The first plate α is parallel or substantially parallel to the second plate β.

In a first particular case, the second plate β is fitted movable between a first guard rail position and the retracted position. In the first guard rail position, the second plate β extends upwards from the first plate a. The second plate β extends vertically or away from the moving device 4 and upwards. By forming a guard rail, the second plate β forms an obstacle to movement of the operator beyond a threshold position when moving away from the moving device 4 which enhances safety when the operator steps backwards and there is an empty space between the additional platform A and the roof panel 7 or when the terminal 1 is not provided with the roof panel 7. FIGS. 7, 8 and 9 represent the first plate α in the position supporting the operator and the second plate β forming a guard rail.

In a second particular case, the first plate a is designed to support the operator and the second plate β moves between a second guard rail position and the retracted position. In the second guard rail position, the second plate β extends downwards from the first plate α. The second plate β extends vertically in the direction of the supplementary platform 7a. By forming a guard rail, the second plate constitutes an obstacle to movement of the operator beyond a threshold position thereby improving safety when the operator is standing on the supplementary platform 7a.

The additional platform A can be configured so that the second plate β presents only one of the positions between the first guard rail position and the second guard rail position. It is also possible for the additional platform A to be configured so that the second plate β only presents two positions between the first guard rail position, the second guard rail position and the retracted position.

In an advantageous embodiment, the additional platform A presses against a rail 4c when the additional platform A is in the second position. Preferentially, the first plate α presses against a rail 4c when the additional platform is in the second position. The use of rail 4c enables the components arranged in the terminal 1 to be limited and the additional platform A to be placed at the right altitude with respect to the moving device 4 by positioning the latter facing rail 4c designed to receive at least one wheel of the carrier vehicle. The force take-up by rail 4c facilitates formation of a compact additional platform. If required, only the first plate presses against rail 4c. It is particularly advantageous to use rail 4c as end-of-travel stop for the additional platform A.

In advantageous manner, the additional platform A is mounted rotatable between the first position and the second position. Such an embodiment is easy to implement. The terminal 1 has a rotation shaft 8 that is preferentially mounted fixed with respect to the moving device 4. It is advantageous for the rotation shaft 8 to be located above the running space of the carrier vehicles. FIG. 4 illustrates a rotation shaft 8 arranged above the vertical of the grip 3.

In a preferential embodiment, the plate is fitted on the framework in the extension of the additional platform so as to extend the additional platform. The plate is arranged between the additional platform and the roofing in the same horizontal plane. The plate is not wide enough to support operator, for example less than 50 cm. Advantageously, the plate is fitted movable between a horizontal position and a vertical position. In the horizontal position, the plate is in the extension of the additional platform that is able to support the operator so that the plate and the additional platform define one and the same support plane of the operator. In the vertical position, the plate is salient downwards at the end of the additional platform so as to reduce the space between the additional platform and the structure supporting the operator thereby enhancing protection against falls. The additional platform forms a work surface and the plate defines a guard rail.

In a preferential configuration, the two ends of the additional platform are terminated by a guard rail 9 that extends in a vertical direction and that is mounted fixed with respect to the moving device 4. In even more preferential manner, when the additional platform A is mounted rotatable, the rotation shaft 8 is mounted fixed with respect to the guard rail 9. The two guard rails 9 form two obstacles at the two ends of the additional platforms to prevent an operator from falling. Preferably, the two guard rails 9 are mounted unmovably with respect to the moving device 4. It is advantageous to use the supports of the roof panel 7 as guard rails 9.

In particularly advantageous manner illustrated in FIGS. 1 to 12, the shrouding 6 forms the additional platform A. FIGS. 1 to 3 illustrate the shrouding 6 designed to form the additional platform A in the first position. In this first position, the shrouding 6 is in the position that prevents access to the moving device 4. This protection position also corresponds to the position of the additional platform that does not allow to the operator to operate on the moving device. The shrouding 6 does not allow access to the moving device 4 from the second side. The shrouding 6 forms an obstacle preventing the operator from passing over to the second side.

FIGS. 4 to 6 illustrate the additional platform A in an intermediate position, i.e. between the first position and the second position.

FIGS. 7 to 12 illustrate the additional platform A in the second position, i.e. in the position able to support operator so that the latter is able to perform operations on the moving device 4. FIGS. 7 to 9 illustrate the operator installed on the additional platform A. FIGS. 10 to 12 illustrate the operator installed on the supplementary platform 7a facing the additional platform A and facing the moving device 4, the additional platform A being located between the operator and the moving device 4.

In one embodiment, the moving device 4 comprises a plurality of wheels 4a, and the plane separating the first side and second side is defined by a vertical surface perpendicularly to the respective wheels 4a that define the running path of the carrier vehicles. The plane passes through the wheels 4a.

In another embodiment, the moving device 4 comprises a plurality of sheaves 4b, and the plane separating the first side and second side is defined by the vertical surface perpendicular to the respective sheaves 4b that define the running path of the carrier vehicles by means of running of the cable 2. The plane passes through the sheaves 4b.

FIGS. 1 to 12 illustrate an embodiment in which the shrouding 6 forms the whole of the additional platform A which enables the space occupation inside the terminal 1 to be limited. It is however also possible to dissociate the additional platform A and the shrouding 6, for example by providing for the additional platform A to be arranged on or above the shrouding 6 in the protection position. It is also possible, in its first position, to provide for the additional platform to only be accessible when the shrouding 6 is in the intervention position.

In one configuration, the additional platform A forms all or part of the shrouding 6. In another configuration, the shrouding 6 forms all or part of the additional platform A.

It is further possible to have an additional platform A that presents a first position that corresponds to a stowing position in the direction of or against the roof panel 7. In other words, in the first position, the additional platform A and the platform 5 are separated by the moving device 4. This configuration is less advantageous than the previous one as it complicates handling by the operator to move from the first position to the second position for the additional platform A and/or it may represent a greater space occupation.

1. A terminal of an aerial transportation installation provided with at least one carrier vehicle, the terminal comprising:
a moving device configured to drive the at least one carrier vehicle in the terminal, the moving device defining a running path of the at least one carrier vehicle in the terminal, the moving device comprising a plurality of moving parts designed to move said at least one carrier vehicle in the terminal;
a platform arranged on a first side of the running path, the platform being configured to allow an operator to move alongside the moving device and to enable him/her to perform maintenance operations on the moving device;
at least one shrouding movable between a first position and a second position, wherein the terminal defines a running space designed to let a grip of the at least one carrier vehicle run, the grip fixing the at least one carrier vehicle to the cable, the moving device being arranged between the platform and the running space;
wherein in the first position the at least one shrouding at least partially covers the moving device to separate the operator on the platform and the moving device and prevent access to the moving device from the platform,
wherein in the second position the at least one shrouding allows access to the moving device from the platform and the at least one shrouding forms an additional platform able to support the operator to enable him/her to perform an operation on the moving device;
and wherein the additional platform is arranged on the second side of the running path facing the platform, the second side being opposite the first side with respect to the running path in a vertical observation.

2. The terminal according to claim 1 wherein, in the first position, the additional platform is at least partially arranged on the first side with respect to the running path.

3. The terminal according to claim 2 wherein, in the first position, the additional platform is arranged mainly on the first side with respect to the running path.

4. The terminal according to claim 1 wherein, in the second position, the additional platform is arranged in a space designed to be occupied by the grip, the additional platform forming an obstacle to running of the at least one carrier vehicle in the terminal.

5. The terminal according to claim 1 further comprising a roof panel and wherein the roof panel defines a supplementary platform designed to support the operator, the supplementary platform being offset from the additional platform in a first direction perpendicular to the running path of said at least one carrier vehicle, the supplementary platform being located at a lower height than an height of the additional platform and offset to arrange the additional platform between a plurality of wheels forming the plurality of moving parts and supplementary platform so that the additional platform forms a work surface.

6. The terminal according to claim 5 wherein the moving device comprises at least one wheel configured to move the carrier vehicle in the terminal, and wherein an altitude of the additional platform is lower than an altitude of an axis of rotation of the at least one wheel.

7. The terminal according to claim 1 wherein the additional platform is formed by a first plate and a second plate, the second plate being fitted movable with respect to the first plate, the second plate being fitted movable between a protection position and a retracted position, wherein in the protection position the second plate extends upwards from the first plate and wherein in the retracted position the second plate is pressing against the first plate.

8. The terminal according to claim 1 wherein, in the first position, the additional platform forms the at least one shrouding.

9. The terminal according to claim 1 wherein the additional platform is mounted rotatable between the first position and the second position.

10. A method for performing maintenance of a terminal of an aerial transportation installation comprising the following steps:
providing a terminal according to claim 1;
moving the additional platform from the first position to the second position, the second position supporting an operator performing operations on the moving device, the first position being a position where the additional platform is outside the running space of the carrier vehicles in the terminal.
